(19) United States
(12) Patent Application Publication
(10) Pub. No.: US 2014/0282275 A1
(43) Pub. Date: Sep. 18, 2014

(54) DETECTION OF A ZOOMING GESTURE

(71) Applicant: QUALCOMM INCORPORATED, San Diego, CA (US)

(72) Inventors: Andrew J. Everitt, Cambridge (GB); Nadine B. Christiansen, Highlands Caldecote (ZA)

(73) Assignee: QUALCOMM Incorporated, San Diego, CA (US)

(21) Appl. No.: 13/843,506

(22) Filed: Mar. 15, 2013

(51) Int. Cl. G06F 3/01

(52) U.S. Cl. CPC G06F 3/017
USPC 715/863

(57) ABSTRACT

Methods, systems, computer-readable media, and apparatuses for implementation of a contactless zooming gesture are disclosed. In some embodiments, a remote detection device detects a control object associated with a user. An attached computing device may use the detection information to estimate a maximum and minimum extension for the control object, and may match this with the maximum and minimum zoom amount available for a content displayed on a content surface. Remotely detected movement of the control object may then be used to adjust a current zoom of the content.

### BACKGROUND

Aspects of the disclosure relate to display interfaces. In particular, a contactless interface and an associated method are described that control content in a display using detection of a contactless gesture.

Standard interfaces for display devices typically involve physical manipulation of an electronic input. A television remote control involves pushing a button. A touch screen display interface involves detecting the touch interaction with the physical surface. Such interfaces have numerous drawbacks. As an alternative, a person's movements may be used to control electronic devices. A hand movement or movement of another part of the person's body can be detected by an electronic device and used to determine a command to be executed by the device (e.g., provided to an interface being executed by the device) or to be output to an external device. Such movements by a person may be referred to as a gesture. Gestures may not require the person to physically manipulate an input device.

### BRIEF SUMMARY

Certain embodiments are described related to detection of a contactless zooming gesture. One potential embodiment includes a method of detecting such a gesture by remotely detecting a control object associated with a user and initiating, in response to a zoom initiating input, a zoom mode. Details of a content including a current zoom amount, a minimum zoom amount, and a maximum zoom amount are then identified, and estates are made of a maximum range of motion of the control object including a maximum extension and a minimum extension. The minimum zoom amount and the maximum zoom amount are then matched to the maximum extension and the minimum extension to create a zoom match along a zoom vector from the maximum extension to the minimum extension. The remote detection device is then used to remotely detect a movement of the control object along the zoom vector and the current zoom amount of the content is adjusted in response to the detection of the movement of the control object along the zoom vector and based on the zoom match.

In additional alternative embodiments, the control object may include a user's hand. In still further embodiments, remotely detecting movement of the control object along the zoom vector may involve detecting a current position of the user's hand in three dimensions; estimating the zoom vector as a motion path of the user's hand as the user pulls or pushes a closed palm toward or away from the user; and detecting the motion path of the user's hand as the user pulls or pushes the closed palm toward or away from the user.

Additional alternative embodiments may include ending the zoom mode by remotely detecting, using the remote detection device, a zoom disengagement motion. In additional alternative embodiments, the control object comprises a hand of the user; and detecting the zoom disengagement motion comprises detecting an open palm position of the hand after detecting a closed palm position of the hand. In additional alternative embodiments, detecting the zoom disengagement motion comprises detecting that the control object has deviated from zoom vector by more than a zoom vector threshold amount. In additional alternative embodiments, the remote detection device comprises an optical camera, a stereo camera, a depth camera, or a hand mounted inertial sensor such as a wrist band which may be combined with a hand or wrist mounted EMG sensor to detect the open palm position and the closed palm position in order to determine a grabbing gesture. In additional alternative embodiments, the control object is a hand of the user and zoom initiating input comprises a detection by the remote detection device of an open palm position of the hand followed by a closed palm position of the hand, when the hand is in a first location along the zoom vector.

Still further embodiments may involve matching the first location along the zoom vector and the current zoom amount as part of the zoom match. In additional alternative embodiments, identifying details of the content may also include comparing the minimum zoom amount and the maximum zoom amount to a maximum single extension zoom amount and adjusting the zoom match to associate the minimum extension with a first capped zoom setting and the maximum extension with a second capped zoom setting. In such embodiments, a zoom difference between the first capped zoom setting and the second capped zoom setting may be less than or equal to the maximum single extension zoom amount. Still further embodiments may involve ending the zoom mode by remotely detecting, using the remote detection device, a zoom disengagement motion when the hand is in a second location along the zoom vector different from the first location. Still further embodiments may additionally involve initiating, in response to a second zoom initiating input, a second zoom mode when the hand is at a third location along the zoom vector different from the second location and adjusting the first capped zoom setting and the second capped zoom setting in response to a difference along the zoom vector between the second location and the third location.

One potential embodiment may be implemented as an apparatus made up of a processing module, a computer readable storage medium coupled to the processing module, a display output module coupled to the processing module; and an image capture module coupled to the processing module. In such an embodiment, the computer readable storage medium may include computer readable instructions that, when executed by the computer processor, cause the computer processor to perform a method according to various embodiments. One such embodiment may involve detecting a control object associated with a user using data received by the image capture module; initiating, in response to a zoom initiating input, a zoom mode; identifying details of a content including a current zoom amount, a minimum zoom amount, and a maximum zoom amount; estimating a maximum range of motion of the control object including a maximum extension and a minimum extension; matching the minimum zoom amount and the maximum zoom amount to the maximum extension and the minimum extension to create a zoom match along a zoom vector from the maximum extension to the minimum extension; remotely detecting, using the image capture module, a movement of the control object along the zoom vector; and adjusting the current zoom amount of the content in response to the detection of the movement of the control object along the zoom vector and based on the zoom match.

An additional alternative embodiment may further include an audio sensor; and a speaker. In such an embodiment, the zoom initiating input may comprise a voice command received via the audio sensor. In additional alternative embodiments, the current zoom amount may be communicated to a server infrastructure computer via the display output module.

One potential embodiment may be implemented as a system that includes a first camera; a first computing device communicatively coupled to the first camera; and an output display communicatively coupled to the first computing device. In such an embodiment, the first computing device may include a gesture analysis module that identifies a control object associated with a user using an image from the first camera, estimates a maximum range of motion of the control object including a maximum extension and a minimum extension along a zoom vector between the user and the output display, and identifies motion along the zoom vector by the control object. In such an embodiment the first computing device may further include a content control module that outputs a content to the output display, identifies details of the content including a current zoom amount, a minimum zoom amount, and a maximum zoom amount, matches the minimum zoom amount and the maximum zoom amount to the maximum extension and the minimum extension to create a zoom match along the zoom vector, and adjusts the current zoom amount of the content in response to the detection of a movement of the control object along the zoom vector and based on the zoom match.

Another embodiment may further include a second camera communicatively coupled to the first computing device. In such an embodiment, the gesture analysis module may identify an obstruction between the first camera and the control object; and then detect the movement of the control object along the zoom vector using a second image from the second camera.

Another embodiment may be a method of adjusting a property of a computerized object or function, the method comprising: detecting a control object; determining total available motion of the control object in at least one direction; detecting movement of the control object; and adjusting a property of a computerized object or function based on the detected movement, wherein an amount of the adjustment is based on a proportion of the detected movement compared to the total available motion.

Further embodiments may function where the property is adjustable within a range, and wherein the amount of adjustment in proportion to the range is approximately equivalent to the proportion of the detected movement compared to the total available motion. Further embodiments may function where the property comprises a zoom. Further embodiments may function where the property comprises a pan or scroll. Further embodiments may function where the property comprises a volume level control. Further embodiments may function where the control object comprises a user's hand. Further embodiments may function where the total available motion is determined based on an anatomical model. Further embodiments may function where the total available motion is determined based on data collected over time for a user.

Further embodiments may comprise determining total available motion in a second direction, and controlling two separate objects or functions with each direction wherein the first direct controls zoom and the second direction controls panning.

An additional embodiment may be method for causing a zoom level to be adjusted, the method comprising: determining a zoom space based on a position of a control object associated with a user when zoom is initiated and a reach of the user relative to the position; detecting movement of the control object; and causing a zoom level of a displayed element to be adjusted based on a magnitude of the detected movement compared to the determined zoom space.

Further embodiments may function where the causing comprises causing the element to be displayed at a maximum zoom level when the control object is positioned at a first extremum of the zoom space, and causing the element to be displayed at a minimum zoom level when the control object is positioned at a second extremum of the zoom space. Further embodiments may function where the first extremum is located opposite the second extremum. Further embodiments may function where the first extremum is located approximately at the user's torso, and wherein the second extremum is located approximately at a maximum of the reach. Further embodiments may function where there is a dead zone adjacent the first extremum and/or the second extremum. Further embodiments may function where a proportion of increase of the zoom level from a present zoom level to the maximum zoom level is approximately equivalent to a proportion of the detected movement from the position to the first extremum. Further embodiments may function where a proportion of decrease of the zoom level from a present zoom level to the minimum zoom level is approximately equivalent to a proportion of the detected movement from the position to the second extremum.

An additional embodiment may be a method comprising: determining a range of motion of a control object associated with a user including a maximum extension and a minimum extension; detecting, based on information from one or more detection devices, a movement of the control object substantially in a direction associated with a zoom command; and adjusting a current zoom amount of displayed content in response to the detection of the movement of the control object, wherein details of a content are identified including a current zoom amount, a minimum zoom amount, and a maximum zoom amount; and wherein the minimum zoom amount and the maximum zoom amount are matched to the maximum extension and the minimum extension to create a zoom match along the direction from the maximum extension to the minimum extension.

Additional embodiments of such a method may further function where the control object comprises a user's hand, and wherein remotely detecting movement of the control object along a zoom vector comprises: detecting a current position of the user's hand in three dimensions; estimating the direction as a motion path of the user's hand as the user pulls or pushes the hand toward or away from the user; and detecting the motion path of the user's hand as the user pulls or pushes the hand toward or away from the user.

An additional embodiment may further comprise ending the zoom mode by remotely detecting a zoom disengagement motion. Additional embodiments of such a method may further function where the control object comprises a hand of the user; and wherein detecting the zoom disengagement motion comprises detecting an open palm position of the hand after detecting a closed palm position of the hand. Additional embodiments of such a method may further function where the one or more detection devices comprise an optical camera, a stereo camera, a depth camera, or a hand mounted inertial sensor, and wherein a hand or wrist mounted EMG sensor is used to detect the open palm position and the closed palm position.

Additional embodiments of such a method may further function where detecting the zoom disengagement motion comprises detecting that the control object has deviated from zoom vector by more than a zoom vector threshold amount. Additional embodiments of such a method may further function where the control object is a hand of the user; and further comprising detecting a zoom initiating input, wherein the zoom initiating input comprises an open palm position of the hand followed by a closed palm position of the hand.

Additional embodiments of such a method may further function where a first location of the hand along the direction when the zoom initiating input is detected is matched to the current zoom amount.

Additional embodiments of such a method may further function where the details of the content further comprise: comparing the minimum zoom amount and the maximum zoom amount to a maximum single extension zoom amount; and adjusting the zoom match to associate the minimum extension with a first capped zoom setting and the maximum extension with a second capped zoom setting; wherein a zoom difference between the first capped zoom setting and the second capped zoom setting is less than or equal to the maximum single extension zoom amount.

An additional embodiment may further comprise ending a zoom mode by remotely detecting, using the one or more detection devices, a zoom disengagement motion when the hand is in a second location along a zoom vector different from the first location; initiating, in response to a second zoom initiating input, a second zoom mode when the hand is at a third location along the zoom vector different from the second location; and adjusting the first capped zoom setting and the second capped zoom setting in response to a difference along the zoom vector between the second location and the third location.

Additional embodiments of such a method may further function where adjusting the current zoom amount of the content in response to the detection of the movement of the control object along a zoom vector and based on the zoom match comprises: identifying a maximum allowable zoom rate; monitoring the movement of the control object along the zoom vector; and setting a rate of change in zoom to the maximum allowable zoom rate when an associated movement along the zoom vector exceeds a rate threshold until the current zoom amount matches a current control object location on the zoom vector.

Additional embodiments of such a method may further function where the zoom match is further determined based on an analysis of an arm length of the user. Additional embodiments of such a method may further function where the zoom match is estimated prior to a first gesture of the user based on one or more of torso size, height, or arm length; and wherein the zoom match is updated based on an analysis of at least one gesture performed by the user.

Additional embodiments of such a method may further function where the zoom match identifies a dead zone for a space near the minimum extension. Additional embodiments of such a method may further function where the zoom match identifies a second dead zone for a space near the maximum extension.

Another embodiment may be an apparatus comprising: a processing module comprising a computer processor; a computer readable storage medium coupled to the processing module; a display output module coupled to the processing module; and an image capture module coupled to the processing module; wherein the computer readable storage medium comprises computer readable instructions that, when executed by the computer processor, cause the computer processor to perform a method comprising: determining a range of motion of a control object associated with a user including a maximum extension and a minimum extension; detecting, based on information from one or more detection devices, a movement of the control object substantially in a direction associated with a zoom command; and adjusting a current zoom amount of displayed content in response to the detection of the movement of the control object, wherein details of a content are identified including a current zoom amount, a minimum zoom amount, and a maximum zoom amount; and wherein the minimum zoom amount and the maximum zoom amount are matched to the maximum extension and the minimum extension to create a zoom match along the direction from the maximum extension to the minimum extension.

An additional embodiment may further comprise a speaker; wherein the zoom initiating input comprises a voice command received via the audio sensor. An additional embodiment may further comprise an antenna; and a local area network module; wherein the content is communicated to a display from a display output module via the local area network module.

Additional such embodiments may function where the current zoom amount is communicated to a server infrastructure computer via the display output module. An additional embodiment may further comprise a head mounted device comprising a first camera that is communicatively coupled to the computer processor.

An additional embodiment may further comprise a first computing device communicatively coupled to a first camera; and an output display wherein the first computing device further comprises a content control module that outputs a content to the output display. Additional such embodiments may function where the apparatus is a head mounted device (HMD).

Additional such embodiments may function where the output display and the first camera are integrated as components of the HMD. Additional such embodiments may function where the HMD further comprises a projector that projects a content image into an eye of the user. Additional such embodiments may function where the image comprises content in a virtual display surface. Additional such embodiments may function where a second camera is communicatively coupled to the first computing device; and wherein the gesture analysis module identifies an obstruction between the first camera and the control object and detects the movement of the control object along the zoom vector using a second image from the second camera.

An additional embodiment may be a system comprising: means for determining a range of motion of a control object associated with a user including a maximum extension and a minimum extension; means for detecting, based on information from one or more detection devices, a movement of the control object substantially in a direction associated with a zoom command; and means for adjusting a current zoom amount of displayed content in response to the detection of the movement of the control object, wherein details of a content are identified including a current zoom amount, a minimum zoom amount, and a maximum zoom amount; and wherein the minimum zoom amount and the maximum zoom amount are matched to the maximum extension and the minimum extension to create a zoom match along the direction from the maximum extension to the minimum extension.

An additional embodiment may further comprise means for detecting a current position of a user's hand in three dimensions; means for estimating the direction as a motion path of the user's hand as the user pulls or pushes the hand toward or away from the user; and means for detecting the motion path of the user's hand as the user pulls or pushes the hand toward or away from the user.

An additional embodiment may further comprise ending a zoom mode by remotely detecting a zoom disengagement motion.

An additional embodiment may further comprise detecting control object movement where the control object is a hand of the user including detecting an open palm position of the hand after detecting a closed palm position of the hand.

An additional embodiment may further comprise means for comparing the minimum zoom amount and the maximum zoom amount to a maximum single extension zoom amount; and means for adjusting the zoom match to associate the minimum extension with a first capped zoom setting and the maximum extension with a second capped zoom setting; wherein a zoom difference between the first capped zoom setting and the second capped zoom setting is less than or equal to the maximum single extension zoom amount.

An additional embodiment may further comprise means for ending the zoom mode by remotely detecting, using the one or more detection devices, a zoom disengagement motion when the hand is in a second location along a zoom vector different from the first location; means for initiating, in response to a second zoom initiating input, a second zoom mode when the hand is at a third location along the zoom vector different from the second location; and means for adjusting the first capped zoom setting and the second capped zoom setting in response to a difference along the zoom vector between the second location and the third location.

Another embodiment may be a non-transitory computer readable storage medium comprising computer readable instruction that, when executed by a processor, cause a system to: determine a range of motion of a control object associated with a user including a maximum extension and a minimum extension; detect, based on information from one or more detection devices, a movement of the control object substantially in a direction associated with a zoom command; and adjusting a current zoom amount of displayed content in response to the detection of the movement of the control object, wherein details of a content are identified including a current zoom amount, a minimum zoom amount, and a maximum zoom amount; and wherein the minimum zoom amount and the maximum zoom amount are matched to the maximum extension and the minimum extension to create a zoom match along the direction from the maximum extension to the minimum extension.

An additional embodiment may further identify a maximum allowable zoom rate; monitor the movement of the control object along the zoom vector; and setting a rate of change in zoom to the maximum allowable zoom rate when an associated movement along a zoom vector exceeds a rate threshold until the current zoom amount matches a current control object location on the zoom vector. An additional embodiment may further cause the system to: analyze a plurality of user gesture commands to adjust the zoom match.

Additional such embodiments may function where analyzing the plurality of user gesture commands to adjust the zoom match comprises identifying the maximum extension and the minimum extension from the plurality of user gesture commands.

An additional embodiment may further cause the system to: estimate the zoom match prior to a first gesture of the user based on one or more of a torso size, a height, or an arm length. An additional embodiment may further cause the system to: identify a dead zone for a space near the minimum extension. An additional embodiment may further cause the system to: identify a second dead zone near the maximum extension.

While various specific embodiments are described, a person of ordinary skill in the art will understand that elements, steps, and components of the various embodiments may be arranged in alternative structures while remaining within the scope of the description. Also, additional embodiments will be apparent given the description herein, and thus the description is not referring only to the specifically described embodiments, but to any embodiment capable of the function or structure described herein.

### BRIEF DESCRIPTION OF THE DRAWINGS

Aspects of the disclosure are illustrated by way of example. In the accompanying figures, like reference numbers indicate similar elements, and:

FIG. 1A illustrates an environment including a system that may incorporate one or more embodiments;

FIG. 1B illustrates an environment including a system that may incorporate one or more embodiments;

FIG. 1C illustrates an environment including a system that may incorporate one or more embodiments.

FIG. 2A illustrates an environment that may incorporate one or more embodiments;

FIG. 2B illustrates an aspect of a contactless gesture that may be detected in one or more embodiments;

FIG. 3 illustrates one aspect of a method that may incorporate one or more embodiment;

FIG. 4 illustrates one aspect of a system that may incorporate one or more embodiments;

FIG. 5A illustrates one aspect of a system including a head mounted device that may incorporate one or more embodiments; and

FIG. 5B illustrates one aspect of a system that may incorporate one or more embodiments; and

FIG. 6 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Embodiments are directed to display interfaces. In certain embodiments, contactless interfaces and an associated method for control of content in a display using a contactless interface are described. As the input devices and computing power available to users continues to increase, using gestures and in particular free-air gestures to interact with content surfaces is desirable in some situations. One potential navigation interaction involves navigating around large content items using a free-air zoom gesture which may be made relative to a content surface, such as a liquid crystal, plasma display surface, or a virtual display surface presented by a device such as head mounted glasses. Detection of the gesture is not based on any detection at the surface, but is instead based on detection of a control object such as the user's hands by a detection device, as detailed further below. “Remote” and “contactless” gesture detection thus refers herein to the use of sensing devices to detect gestures remote from the display, as contrasted to devices where contact at the surface of a display is used to input commands to control content in a display. In some embodiments, a gesture may be detected by a handheld device, such as a controller or apparatus comprising an inertial measurement unit (IMU). Thus, a device used to detect a gesture may not be remote with respect to the user, but such device and/or gesture may be remote with respect to the display interfaces.

In one example embodiment, a wall mounted display is coupled to a computer, which is in turn further coupled to a camera. When a user interacts with the display from a location that is in view of the camera, the camera communicates images of the user to the computer. The computer recognizes gestures made by the user, and adjusts the presentation of content shown at the display in response to gestures of the user. A particular zooming gesture may be used, for example. In one implementation of the zooming gesture, the user makes a grabbing motion in the air to initiate the zoom, and pushes or pulls a closed fist between the display and the user to adjust the zoom. The camera captures images of this gesture, and communicates them to the computer, where they are processed. The content on the display is shown with a magnification that is modified based on the push or pull motion of the user. Additional details are described below.

As used herein, the terms “computer,” “personal computer” and “computing device” refer to any programmable computer system that is known or that will be developed in the future. In certain embodiments a computer will be coupled to a network such as described herein. A computer system may be configured with processor-executable software instructions to perform the processes described herein. FIG. 6 provides additional details of a computer as described below.

As used herein, the term “component,” “module,” and “system,” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

As used herein, the term “gesture” refers to a movement through space over time made by a user. The movement may be made by any control object under the direction of the user.

As used herein, the term “control object” may refer to any portion of the user's body, such as the hand, arm, elbow, or foot. The gesture may further include a control object that is not part of the user's body, such as a pen, a baton, or an electronic device with an output that makes movements of the device more readily visible to the camera and/or more easily processed by a computer coupled to the camera.

As used herein, the term “remote detection device” refers to any device capable of capturing data associated with and capable of being used to identify a gesture. In one embodiment, a video camera is an example of a remote detection device which is capable of conveying the image to a processor for processing and analysis to identify specific gestures being made by a user. A remote detection device such as a camera may be integrated with a display, a wearable device, a phone, or any other such camera presentation. The camera may additionally comprise multiple inputs, such as for a stereoscopic camera, or may further comprise multiple units to observe a greater set of user locations, or to observe a user when one or more camera modules are blocked from viewing all or part of a user. A remote detection device may detect a gesture using any set of wavelength detection. For example, a camera may include an infrared light source and detect images in a corresponding infrared range. In further embodiments, a remote detection device may comprise sensors other than a camera, such as inertial sensors that may track movement of a control device using an accelerometer, gyroscope or other such elements of a control device. Further remote detection devices may include ultraviolet sources and sensors, acoustic or ultrasound sources and sound reflection sensors, MEMS-based sensors, any electromagnetic radiation sensor, or any other such device capable of detecting movement and/or positioning of a control object.

As used herein, the term “display” and “content surface” refer to an image source of data being viewed by a user. Examples include liquid crystal televisions, cathode ray tube displays, plasma display, and any other such image source. In certain embodiments, the image may be projected to a user's eye rather than presented from a display screen. In such embodiments, the system may present the content to the user as if the content was originating from a surface, even though the surface is not emitting the light. One example is a pair of glasses as part of a head mounted device that provides images to a user.

As used herein, the term “head mounted device” (HMD) or “body mounted device” (BMD) refers to any device that is mounted to a user's head, body, or clothing or otherwise worn or supported by the user. For example, an HMD or a BMD may comprise a device that captures image data and is linked to a processor or computer. In certain embodiments, the processor is integrated with the device, and in other embodiments, the processor may be remote from the HMD. In an embodiment, the head mounted device may be an accessory for a mobile device CPU (e.g., the processor of a cell phone, tablet computer, smartphone, etc.) with the main processing of the head mounted devices control system being performed on the processor of mobile device. In another embodiment, the head mounted device may comprise a processor, a memory, a display and a camera. In an embodiment, a head mounted device may be a mobile device (e.g., smartphone, etc.) that includes one or more sensors (e.g., a depth sensor, camera, etc.) for scanning or collecting information from an environment (e.g., room, etc.) and circuitry for transmitting the collected information to another device (e.g., server, second mobile device, etc.). An HMD or BMD may thus capture gesture information from a user and use that information as part of a contactless control interface.

As used herein, “content” refers to a file or data which may be presented in a display, and manipulated with a zoom comment. Examples may be text files, pictures, or movies which may be stored in any format and presented to a user by a display. During presentation of content on a display, details of content may be associated with the particular display instance of the content, such as color, zoom, details levels, and maximum and minimum zoom amounts associated with content detail levels.

As used herein, “maximum zoom amount” and “minimum zoom amount” refers to a characteristic of content that may be presented on a display. A combination of factors may determine these zoom limits. For example, for a content comprising a picture, the stored resolution of the picture may be used to determine a maximum and minimum zoom amount that enables an acceptable presentation on a display device. “Zoom” as used herein may also be equated to hierarchies (for example of a file structure). In such embodiments, a maximum zoom may be the lowest level (e.g., most specific) hierarchy, while min zoom may be the highest level (e.g., least specific) hierarchy. Thus, a user may traverse a hierarchy or file structure using embodiments as described herein. By zooming in, the user may be able to sequentially advance through the hierarchy or file structure, and by zooming out the user may be able to sequentially retreat from the hierarchy or file structure in some embodiments.

In another embodiment, the head mounted device may include a wireless interface for connecting with the Internet, a local wireless network, or another computing device. In another embodiment, a pico-projector may be associated in the head mounted device to enable projection of images onto surfaces. The head mounted device may be lightweight and constructed to avoid use of heavy components, which could cause the device to be uncomfortable to wear. The head mounted device may also be operable to receive audio/gestural inputs from a user. Such gestural or audio inputs may be spoken voice commands or a recognized user gesture, which when recognized by a computing device may cause that device to execute a corresponding command.

FIGS. 1A and 1B illustrate two potential environments in which embodiments of a contactless zoom may be implemented. Both FIGS. 1A and 1B include a display 14 mounted on surface 16. Additionally, in both figures a hand of the user functions as control object 20. In FIG. 1A, HMD 10 is worn by a user 6. Mobile computing device 8 is attached to user 6. In FIG. 1A, HMD 10 is illustrated as having an integrated camera shown by shading associated with camera field of vision 12. The field of vision 12 for a camera embedded in HMD 10 is shown by the shading, and will move to match head movements of user 6. Camera field of vision 12 is sufficiently wide to include the control object 20 in both an extended and retracted position. An extended position in shown.

In the system of FIG. 1A, the image from HMD 10 may be communicated wirelessly from a communication module within HMD 10 to a computer associated with display 14, or may be communicated from HMD 10 to mobile computing device 8 either wirelessly or using a wired connection. In an embodiment where images are communicated from HMD 10 to mobile computing device 8, mobile computing device 8 may communicate the images to an additional computing device that is coupled to the display 14. Alternatively, mobile computing device 8 may process the images to identify a gesture, and then adjust content being presented on display 14, especially if the content on display 14 is originating from mobile computing device 8. In a further embodiment, mobile computing device 8 may have a module or application that performs an intermediate processing or communication step to interface with an additional computer, and may communicate data to the computer which then adjusts the content on display 14. In certain embodiments, display 14 may be a virtual display created by HMD 10. In one potential implementation of such an embodiment, HMD may project an image into the user's eyes to create the illusion that display 14 is projected onto a surface when the image is actually simple projected from the HMD to the user. The display may thus be a virtual image represented to a user on a passive surface as if the surface were an active surface that was presenting the image. If multiple HMD are networked or operating using the same system, then two or more users may have the same virtual display with the same content displayed at the same time. A first user may then manipulate the content in a virtual display and have the content adjusted in the virtual display as presented to both users.

FIG. 1B illustrates an alternative embodiment, wherein the image detection is performed by camera 18, which is mounted in surface 16 along with display 14. In such an embodiment, camera 18 will be communicatively coupled to a processor that may be part of camera 18, part of display 14, or part of a computer system communicatively coupled to both camera 18 and display 14. Camera 18 has a field of view 19 shown by the shaded area, which will cover the control object in both an extended and retracted position. In certain embodiments, a camera may be mounted to an adjustable control that moves field of view 19 in response to detection of a height of user 6. In further embodiments, multiple cameras may be integrated into surface 16 to provide a field of vision over a greater area, and from additional angles in case user 6 is obscured by an obstruction blocking a field of view of camera 18. Multiple cameras may additionally be used to provide improved gesture data for improved accuracy in gesture recognition. In further embodiments, additional cameras may be located in any location relative to the user to provide gesture images.

FIG. 1C illustrates another alternative embodiment, where image detection is performed by camera 118. In such an embodiment, either or both hands of a user may be detected as control objects. In FIG. 1C, the hands of a user are shown as first control object 130 and second control object 140. Processing of the image to detect control objects 130 and 140 as well as resulting control of the content may be performed by computing device 108 for content displayed on television display 114.

FIG. 2A shows a reference illustration of a coordinate system that may be applied to an environment in an embodiment. In the embodiments of FIGS. 1A and 1B, the x-y plane of FIG. 2A may correspond with surface 16 of FIGS. 1A and 1B. User 210 is shown positioned in a positive z-axis location facing the x-y plane, and user 210 may thus make a gesture that may be captured by a camera, with the coordinates of the motion captured by the camera processed by a computer using the corresponding x, y, and z coordinates as observed by the camera.

FIG. 2B illustrates an embodiment of a zooming gesture according to an embodiment. Camera 218 is shown in a position to capture gesture information associated with control object 220 and user 210. In certain embodiments, user 210 may be operating in the same environment as user 6, or may be considered to be user 6. The z-axis and user 210 locations shown in FIG. 2B correspond roughly to the z-axis and user 210 location of FIG. 2A, with the user facing an x-y plane. FIG. 2B is thus essentially a z-y plane cross section at the user's arm. Extension of the user 210's arm is thus along the z-axis. The control object 220 of FIG. 2B is a hand of the user. Starting zoom position 274 is shown as roughly a neutral position of a user arm with the angle of the elbow at 90 degrees. This may also be considered the current zoom position at the start of the zoom mode. As control object 220 is extended in available movement away from the body 282, control object moves to a max zoom out position 272, which is at an extreme extension. As control object is retracted in an available movement towards the body 284, control object 220 moves to max zoom in position 276 at the opposite extreme extension. Max zoom out position 272 and max zoom in position 276 thus correspond to a maximum extension and a minimum extension for a maximum range of motion of the control object, which is considered the distance along zoom vector 280 as shown in FIG. 2B. In alternative embodiments, the zoom in and zoom out positions may be reversed. Dead zone 286 is shown that may be set to accommodate variations in user flexibility and comfort in extreme positions of gesture action. As such, in certain embodiments, there may be dead zones on either side of the of the zoom vector. This may additionally deal with difficulty presented in detecting and/or distinguishing a control object when the control object is very close to the body. In one embodiment, a zone within a certain distance of the user's body may be excluded from the zooming range, such that when the hand or other control object is within the certain distance, no zoom change occurs in response to movement of the control object. Dead zone 286 is thus not considered part of the maximum range of motion estimated by a system in determining zoom vector 280 and creating any zoom match between content and a control object. If a control object enters dead zone 286, the system may essentially pause the zoom action at the extreme zoom of the current control vector until the zoom mode is terminated by a detected terminating command or until the control object leaves dead zone 286 and returns to movement along the control vector.

A zoom match, then, may be considered as a correlation made between a user control object location and a current zoom level for content that is being presented on a display. As the system detects movement of the control object sliding along the zoom vector, the corresponding zoom adjusted along a zoom level to match. In alternative embodiments, the zoom along the vector might not be uniform. In such embodiments, the amount of zoom might vary based on an initial hand position is (e.g., if hand is almost all the way extended, but content is already zoomed almost all the way in). Also, amount of zoom could slow as you reach the limits, such that extreme edges of a user reach are associated with a smaller amount of zoom over a given distance other than areas of the user's reach. In one potential embodiment, this may set such a reduced zoom so long as max zoom is reached when hand is at the border between 284 and 286.

This gesture of FIG. 2 may be likened to a grabbing of content and drawing it towards the user or pushing it away from the user as if the user were interacting with a physical object by moving it relative to the user's eyes. In FIG. 2, an apple is shown as zoomed out in max zoom out position 272 at a maximum extension, and zoomed in at max zoom in position 276 at a minimum extension. The gesture is made roughly along a vector from the user's forearm toward the content plane relative to the content being manipulated as shown on a content surface. Whether the content is on a vertical or horizontal screen, the zoom motion will be roughly along the same line detailed above, but may be adjusted by the user to compensate for the different relative view from the user to the content surface.

In various embodiments, max zoom out position 272 and maximum zoom in position 276 may be identified in different ways. In one potential embodiment, an initial image of a user 210 captured by camera 218 may include images of an arm of the user, and a maximum zoom out and zoom in position may be calculated from images of the user 210's arm. This calculation may be updated as additional images are received, or may be modified based on system usage, where an actual maximum zoom in and zoom out position are measured during system operation. Alternatively, the system may operate with a rough estimate based on user height or any other simple user measurement. In further alternative embodiments, a model skeletal analysis may be done based on images captured by camera 218 or some other camera, and max zoom out 272 and max zoom in 276 may be calculated from these model systems. In an embodiment where inertial sensors are used to detect motion (or even if camera is used), motion over time may give a distribution that indicates maximum and minimum. This may enable a system to identify calibration factors for an individual user either based on an initial setup of the system, or based on an initial estimate that is adjusted as the user makes gesture commands and the system reacts while calibrating the system to the user's actual motions for future gesture commands.

During system operation zoom vector 280 may be identified as part of the operation to identify a current location of control object 220 and to associate an appropriate zoom of content in a display with the position of zoom vector 280. Because a gesture as illustrated by FIG. 2B may not always be perfectly along the z-axis as shown, and the user 210 may adjust and turn position during operation, zoom vector 280 may be matched to the user 210 as the user 210 shifts. When the user 210 is directly facing the x-y plane, the zoom vector 280 may be shifted at an angle. In alternative embodiments, if only the portion of the zoom vector 280 along the z-axis is analyzed, the zoom vector 280 may be shortened as the user 210 shifts from left to right, or may be adjusted along the z-axis as user 210 shifts a user center of gravity along the z-axis. This may maintain a specific zoom associated with zoom vector 280 even as control object 220 moves in space. The zoom is thus associated with the user arm extension in such embodiments, and not solely with control object 220 position. In further alternative embodiments, user body position, zoom vector 280, and control object 220 position may be blended and averaged to provide a stable zoom and to avoid zoom jitter due to small user movements or breathing motions.

In further embodiments, a user may operate with a control motion that extends off the z-axis in the y and/or x direction. For example, some users 210 may make a movement towards the body 284 that also lowers the control object 220 toward the user's feet. In such an environment, certain embodiments may set zoom vector 280 to match this control motion.

Detection of a hand or hands of the user may be done by any means such as the use of an optical camera, stereo camera, depth camera, inertial sensors such as a wrist band or ring, or any other such remote detection device. In particular, the use of head mounted displays are one option for convenient integration of free-air gesture control as described further in FIG. 5, but other examples may use such a gestural interaction system, such as media center TVs, shop window kiosks, and interfaces relating to real world displays and content surfaces.

FIG. 3 then describes one potential method of implementing a contactless zooming gesture for control of content in a display. As part of FIG. 3, content such as a movie, a content video image, or a picture are shown in a display such as display 14 of FIG. 1, a display 540 of HMD 10, or display output module 460 of FIG. 4. A computing device controls a zoom associated with the content and the display. Such a computing device may be a computing device 600 implementing system 400, or an HMD 10, or any combination of processing elements described herein. A contactless control camera coupled to the computer observes a field of vision, as shown in FIGS. 1A and 1B, and a user is within the field of view being observed by the control camera. Such a camera may be equivalent to image capture module 410, cameras 503, sensor array 500, or any appropriate input device 615. In certain embodiments, a contactless control camera may be replaced with any sensor such as an accelerometer or other device that does not capture an image. In 305, a computing device determines a range of motion for a control object associated with a user. Just as above, the computing device may be a computing device 600 implementing system 400, or an HMD 10, or any combination of processing elements described herein The computing device may also function in controlling the display zoom to accept an input initiating a zoom mode in 310. In 310 then, as part of this input, the method involves detecting, based on information from one or more detection devices, a movement of the control object substantially in a direction associated with a zoom command. In some embodiments, a minimum zoom amount and a maximum zoom amount for the zoom command are substantially matched to the maximum extension and the minimum extension determined in 305. In some embodiments, the minimum zoom is matched to the minimum extension, and the maximum zoom is matched to the maximum extension. In other embodiments, the maximum zoom is matched to the minimum extension, and the minimum zoom is matched to the maximum extension. Various embodiments may accept a wide variety of zoom initiating inputs, including differing modes where differing commands are accepted. To prevent accidental gesture input as a user enters, walks across a field of view of the control camera, or performs other actions within the field of view of the control camera, the computer may not accept certain gestures until a mode initiating signal is received. A zoom initiating input may be a gesture recognized by the control camera. One potential example would be a grabbing motion, as illustrated by FIG. 2B. The grabbing motion may be detection of an open hand or palm followed by detection of a closed hand or palm. The initial position of the closed hand is then associated with zoom starting position 274 as shown by FIG. 2B.

In alternative embodiments, a sound or voice command may be used to initiate the zoom mode. Alternatively a button or remote control may be used to initiate the zoom mode. The zoom starting position may thus be either the position of the control object when the command is received, or a settled control object position that is stationary for a predetermined amount of time following the input. For example if a voice command is issued, and the user subsequently moves the control object from a resting position with the arm extended in the y-direction and the elbow at a near 180 degree angle to an expected control position with the elbow at an angle nearer to 90 degrees, then the zoom starting position may be set after the control object is stationary for a predetermined time in a range of the expected control position. In some embodiments, one or more other commands may be detected to initiate the zoom mode. In 315, the system adjusts a current zoom amount of displayed content in response to the detection of the movement of the control object. For example, a content control module 450 and/or a user control 515 may be used to adjust a zoom on a display 540 of HMD 10, or display output module 460 of FIG. 4. In some embodiments, details of a content are identified including a current zoom amount, a minimum zoom amount, and a maximum zoom amount. In certain embodiments, a zoom starting position is identified and movement of the control object along the zoom vector is captured by the camera and analyzed by the computing device. As the control object moves along the zoom vector, the content zoom presented at the display is adjusted by the computing device. In additional embodiments, the maximum extension and minimum extension may be associated with a resolution or image quality of the content and a potential zoom. The maximum range of motion and the minimum range of motion including the maximum extension and the minimum extension possible or expected for the gesture of a user may be calculated or estimated, as described above. In certain embodiments, the minimum and maximum zoom amount is matched to the user's extension to create a zoom vector, as described above. Thus the minimum zoom amount and the maximum zoom amount may be matched to the maximum extension and the minimum extension to create a zoom match along the direction from the maximum extension to the minimum extension in some embodiments.

Following this, in certain embodiments an input terminating the zoom mode is received. As above for the input initiating the zoom mode, the terminating input may either be a gesture, an electronic input, a sound input, or any other such input. Following receipt of the input terminating the zoom mode, the current zoom amount, which is the zoom level for the content that is being presented at the display, is maintained until another input is received initiating a zoom mode.

In various embodiments, when determining the zoom vector and analyzing images to identify a gesture, a stream of frames containing x, y, and z coordinates of the user's hands and optionally other joint locations may be received by a remote detection device and analyzed to identify the gesture. Such information may be recorded within a framework or coordinate system identified by the gesture recognition system as shown in FIG. 2A.

For a grab and zoom gesture system detailed above, the system may use image analysis techniques to detect the presence then absence of an open palm in a position between the user and the content surface to initiate the zoom mode. The image analysis may utilize depth information if that is available.

When the engagement gesture is detected, a number of parameters may be recorded: 1. The current position of the hand in 3 dimensions; 2. Details of the object being zoomed including the amount the object is currently zoomed by, a minimum zoom amount, and a maximum zoom amount; 3. An estimation of how far the user can move their hand from its current position towards and/or away from the content; and/or 4. A vector, the ‘zoom vector’, describing the motion path of the user's hand as the user pulls/pushes content towards/away from themselves.

In certain embodiments, a zoom match may then be created to match the maximum zoom amount with an extreme extension or retraction of the user's hand, and to match the minimum zoom with the opposite extreme movement. In other embodiments, a certain portion of the range of motion may be matched, instead of the full range of motion.

The available space the user has for hand movement may be calculated by comparing the current hand position with the position of the user's torso. Various embodiments may use different methods for calculating the available hand space. In one potential embodiment using an assumed arm length, for example 600 mm, the space available to zoom in and zoom out may be calculated. If a torso position is unavailable the system may simply divide the length of the arm in 2. Once an engage gesture is identified, zooming begins. This uses the current position of the hand and applies a ratio of the hand position along the ‘zoom vector’ against the calculated range to the target object's zoom parameters as recorded at engagement and shown in FIG. 2A. During zooming the user's body position may be monitored; if it changes then the zoom vector may be re-evaluated to adjust for the change in relative position of the user and the content that they are manipulating. When using depth camera based hand tracking, the z-axis tracking can be susceptible to jitter. To alleviate this a check may be made for excessive change in zoom. In cases where the calculated change in object zoom level is deemed excessive, for example as caused by jitter or caused by a shake or sudden change in the control object, the system may ignore that frame of tracker data. Thus, a consistency of the zoom command data may be determined, and inconsistent data discarded or ignored.

A zoom disengagement command may be calculated as the reverse gesture of the initiating gesture. When the open palm is detected, when the hand moves in a significant fashion away from the zoom vector, or when any opening of the grabbing gesture is detected within a predetermined tolerance, the zoom function may be released and a display of the content fixed until an additional control function is initiated by a user.

In further alternative embodiments, additional zoom disengagement gestures may be recognized. In one potential example, the zoom engagement motion is the grabbing or grasping motion identified above. The zoom is adjusted as the control object moves along the zoom vector. In certain embodiments, a zoom vector threshold may identify a limit for the zoom vector. If a control object exceeds a zoom vector threshold amount, the system may assume that the control object has moved away from the zoom vector even if an open palm is not detected and the zoom mode may be disengaged. This may occur if, for example, a user drops the user's hand to a resting mode beside the user's body without presenting an open palm. In still further embodiments, going beyond max zoom or min zoom may automatically disengage. If a jerk or sudden jitter is detected, it may be assumed that the user's arm has locked and a max has been reached. Also, disengage could include voice commands or controller input may be associated with out of character acceleration or jerk that may be filtered by a system to create a smooth response to gestures. In some embodiments, a user movement that exceeds a threshold distance outside of the zoom vector may be interpreted as a disengagement. For example, when a user is moving a hand in a z direction, signification movement in an x and/or y direction may comprise a disengagement.

In certain embodiments where content being presented has an maximum and minimum zoom amount that prevents small movements of the control object from providing meaningful zoom adjustments, the zoom amount may be capped to a maximum and minimum zoom amount that is less than the possible maximum and minimum zoom amount of the content. An example may be a system capable of zooming from a local top down satellite picture of a house out to a picture of the planet. For such a system, the maximum change in zoom may be capped for a given zoom starting position. To achieve zoom in or zoom out beyond the cap, the zoom mode may be terminated and restarted multiple times, with an incremental zoom occurring during each initiation of the zoom mode. Such an implementation may be compared to grabbing a rope and repeatedly pulling the rope toward the user to create increasing zoom amounts using a contactless zoom mode. Such an embodiment is described in additional detail below.

For embodiments where the available zoom for the content is not above a threshold for zoom determined to be excessive for a single control object zoom range of motion, the user may repeatedly zoom in and out with motion along the zoom vector until the input terminating the zoom mode is received. In certain embodiments, a maximum zoom rate may be established, such that if the control object moves between zoom settings at a rate faster than the computing device can follow, or faster than is appropriate for secondary considerations such as motion input considerations or illness of the user, the zoom may track toward a current zoom associated with the control objects position along the zoom vector, and settle at the zoom position associated with the control objects position along the vector in a smoothed fashion to provide a smoother user experience. This essentially allows a system to set a rate of change in zoom to the maximum change in zoom rate allowed by the system when the associated movement along the zoom vector exceeds a threshold. In certain embodiments, a user might be able to pan at the same time as a zoom command is initiated (e.g., by moving hand in x, y while zooming in). Initiating of a zoom mode does not then necessarily restrict a system from performing other manipulations on displayed content besides a zoom adjustment. Also, in certain such embodiment, an amount of pan could be determined in similar fashion based on potential movement along x and y axis for pan while movement along the z axis is used for zoom. In certain embodiments, if a user is zooming and panning at same time and an object becomes centered in screen, then the potential zoom/zoom matching might be dynamically reset to the characteristics of that object. In one embodiment, zooming all the way in on the object will act as an object selection command for the object. Object selection may thus be another gesture command integrated with a zoom mode in certain embodiments.

Similarly, in various embodiments the zoom described above may be used to adjust any one dimensional setting of a device. As described above, zoom may be considered a one dimensional setting associated with content displayed in a display surface. Similarly, volume of a speaker output may be a one dimensional setting that may be associated with a zoom vector and adjusted with a zoom gesture command. Scrolling or selection along a linear set of objects or along a one dimensional scroll of a document may similarly be associated with a zoom vector and adjusted in response to a zoom gesture command as described herein.

FIG. 4 illustrates an embodiment of a system 400 for determining a gesture performed by a person. In various alternative embodiments, system 400 may be implemented among distributed components, or may be implemented in a single device or apparatus such as a cellular telephone with an integrated computer processor with sufficient processing power to implement the modules detailed in FIG. 4. More generally, system 400 may be used for tracking a specific portion of a person. For instance, system 400 may be used for tracking a person's hands. System 400 may be configured to track one or both hands of a person simultaneously. Further, system 400 may be configured to track hands of multiple persons simultaneously. While system 400 is described herein as being used to track the location of a persons' hands, it should be understood that system 400 may be configured to track other parts of persons, such as heads, shoulders, torsos, legs, etc. The hand tracking of system 400 may be useful for detecting gestures performed by the one or more persons. System 400 itself may not determine a gesture performed by the person or may not perform the actual hand identification or tracking in some embodiments; rather, system 400 may output a position of one or more hands, or may simply output a subset of pixels likely to contain foreground objects. The position of one or more hands may be provided to and/or determined by another piece of hardware or software for gestures, which might be performed by one or more persons. In alternative embodiments, system 400 may be configured to track a control device held in a user's hands or attached to part of a user's body. In various embodiments, then, system 400 may be implemented as part of HMD 10, mobile computing device 8, computing device 108, or any other such portion of a system for gesture control.

System 400 may include image capture module 410, processing module 420, computer-readable storage medium 430, gesture analysis module 440, content control module 450, and display output module 460. Additional components may also be present. For instance, system 400 may be incorporated as part of a computer system, or, more generally, a computerized device. Computer system 600 of FIG. 6 illustrates one potential computer system which may be incorporated with system 400 of FIG. 4. Image capture module 410 may be configured to capture multiple images. Image capture module 410 may be a camera, or, more specifically, a video camera. Image capture module 410 may capture a series of images in the form of video frames. These images may be captured periodically, such as 30 times per second. The images captured by image capture module 410 may include intensity and depth values for each pixel of the images generated by image capture module 410.

Image capture module 410 may project radiation, such as infrared radiation (IR) out into its field-of-view (e.g., onto the scene). The intensity of the returned infrared radiation may be used for determining an intensity value for each pixel of image capture module 410 represented in each captured image. The projected radiation may also be used to determine depth information. As such, image capture module 410 may be configured to capture a three-dimensional image of a scene. Each pixel of the images created by image capture module 410 may have a depth value and an intensity value. In some embodiments, an image capture module may not project radiation, but may instead rely on light (or, more generally, radiation) present in the scene to capture an image. For depth information, the image capture module 410 may be stereoscopic (that is, image capture module 410 may capture two images and combine them into a single image having depth information) or may use other techniques for determining depth.

The images captured by image capture module 410 may be provided to processing module 420. Processing module 420 may be configured to acquire images from image capture module 410. Processing module 420 may analyze some or all of the images acquired from image capture module 410 to determine the location of one or more hands belonging to one or more persons present in one or more of the images. Processing module 420 may include software, firmware, and/or hardware. Processing module 420 may be in communication with computer-readable storage medium 430. Computer-readable storage medium 430 may be used to store information related to background models and/or foreground models created for individual pixels of the images captured by image capture module 410. If the scene captured in images by image capture module 410 is static, it can be expected that a pixel at the same location in the first image and the second image corresponds to the same object. As an example, if a couch is present at a particular pixel in a first image, in the second image, the same particular pixel of the second image may be expected to also correspond to the couch. Background models and/or foreground models may be created for some or all of the pixels of the acquired images. Computer-readable storage medium 430 may also be configured to store additional information used by processing module 420 to determine a position of a hand (or some other part of a person's body). For instance, computer-readable storage medium 430 may contain information on thresholds (which may be used in determining the probability that a pixel is part of a foreground or background model) and/or may contain information used in conducting a principal component analysis.

Processing module 420 may provide an output to another module, such as gesture analysis module 440. Processing module 420 may output two-dimensional coordinates and/or three-dimensional coordinates to another software module, hardware module, or firmware module, such as gesture analysis module 440. The coordinates output by processing module 420 may indicate the location of a detected hand (or some other part of the person's body). If more than one hand is detected (of the same person or of different persons), more than one set of coordinates may be output. Two-dimensional coordinates may be image-based coordinates, wherein an x-coordinate and y-coordinate correspond to pixels present in the image. Three-dimensional coordinates may incorporate depth information. Coordinates may be output by processing module 420 for each image in which at least one hand is located. Further, the processing module 420 may output one or more subsets of pixels having likely background elements extracted and/or likely to include foreground elements for further processing.

Gesture analysis module 440 may be any one of various types of gesture determination systems. Gesture analysis module 440 may be configured to use the two- or three-dimensional coordinates output by processing module 420 to determine a gesture being performed by a person. As such, processing module 420 may output only coordinates of one or more hands, determining an actual gesture and/or what function should be performed in response to the gesture may be performed by gesture analysis module 440. It should be understood that gesture analysis module 440 is illustrated in FIG. 4 for example purposes only. Other possibilities, besides gestures, exist for reasons as to why one or more hands of one or more users may be desired to be tracked. As such, some other module besides gesture analysis module 440 may receive locations of parts of persons' bodies.

Content control module 450 may similarly be implemented as a software module, hardware module, or firmware module. Such a module may be integrated with processing module 420 or structured as a separate remote module in a separate computing device. Content control module 450 may comprise a variety of controls for manipulating content to be output to a display. Such controls may include play, pause, seek, rewind, and zoom, or any other similar such controls. When gesture analysis module 440 identifies an input initiating a zoom mode, and further identifies movement along a zoom vector as part of a zoom mode, the movement may be communicated to content control module to update a current zoom amount for a content being displayed at a present time.

Display output module 460 may further be implemented as a software module, hardware module, or firmware module. Such a module may include instructions matched to a specific output display that presents content to the user. As the content control module 450 receives gesture commands identified by gesture analysis module 440, the display signal being output to the display by display output module 460 may be modified in real-time or near real-time to adjust the content.

In certain embodiments, particular displays coupled to display output module 460 may have a capped zoom setting which identifies an excessive amount of zoom for a single range of motion. For a particular display, for example changes in zoom greater than 500% may be identified as problematic, where a user may have difficulty making desired zoom adjustments or viewing content during a zoom mode without excessive changes in the content presentation for small movements along the zoom vector that would be difficult for a user to process. In such embodiments, the content control module 450 and/or display output module 460 may identify a maximum single extension zoom amount. When a zoom amount is initiated, the zoom match along a zoom vector may be limited to the maximum single extension zoom amount. If this is 500%, and the content allows a 1000% zoom, the user may use the entire zoom amount by initiating the zoom mode at a first zoom level, zooming the content within the allowed zoom amount before disengaging the zoom amount, the reengaging the zoom mode with the control object at a different location along the zoom vector to further zoom the content. In an embodiment where a closed palm initiates the zoom mode, this zoom gesture may be similar to grabbing the rope at an extended position, pulling the rope toward the user, releasing the rope when the hand is near the user, and then repeating the motion with a grab at an extended position and a release at a position near the user's body to repeatedly zoom in along the maximum zoom of the content, while each zoom stays within the maximum single extension zoom amount of the system.

In such an embodiment, instead of matching the maximum and minimum zoom available to the content as part of a zoom match, the zoom match and zoom vector match the user's extension to first capped zoom setting and the second capped zoom setting, so that the change in zoom available within the minimum extension and maximum extension is within the maximum single extension zoom amount.

FIGS. 5A and 5B describe one potential embodiment of a head mounted device such as HMD 10 of FIG. 1. In certain embodiments, a head mounted device as described in these figures may further be integrated with a system for providing virtual displays through the head mounted device, where a display is presented in a pair of glasses or other output display the provides the illusion that the display is originating from a passive display surface.

FIG. 5A illustrates components that may be included in embodiments of head mounted devices 10. FIG. 5B illustrates how head mounted devices 10 may operate as part of a system in which a sensor array 500 may provide data to a mobile processor 507 that performs operations of the various embodiments described herein, and communicates data to and receives data from a server 564. It should be noted that the processor 507 head mounted device 10 may include more than one processor (or a multi-core processor) in which a core processor may perform overall control functions while a coprocessor executes applications, sometimes referred to as an application processor. The core processor and applications processor may be configured in the same microchip package, such as a multi-core processor, or in separate chips. Also, the processor 507 may be packaged within the same microchip package with processors associated with other functions, such as wireless communications (i.e., a modem processor), navigation (e.g., a processor within a GPS receiver), and graphics processing (e.g., a graphics processing unit or “GPU”).

The head mounted device 10 may communicate with a communication system or network that may include other computing devices, such as personal computers and mobile devices with access to the Internet. Such personal computers and mobile devices may include an antenna 551, a transmitter/receiver or transceiver 552 and an analog to digital converter 553 coupled to a processor 507 to enable the processor to send and receive data via a wireless communication network. For example, mobile devices, such as cellular telephones, may access the Internet via a wireless communication network (e.g., a Wi-Fi or cellular telephone data communication network). Such wireless communication networks may include a plurality of base stations coupled to a gateway or Internet access server coupled to the Internet. Personal computers may be coupled to the Internet in any conventional manner, such as by wired connections via an Internet gateway (not shown) or by a wireless communication network.

Referring to FIG. 5A, the head mounted device 10 may include a scene sensor 500 and an audio sensor 505 coupled to a control system processor 507 which may be configured with a number of software modules 510-525 and connected to a display 540 and audio output 550. In an embodiment, the processor 507 or scene sensor 500 may apply an anatomical feature recognition algorithm to the images to detect one or more anatomical features. The processor 507 associated with the control system may review the detected anatomical features in order to recognize one or more gestures and process the recognized gestures as an input command. For example, as discussed in more detail below, a user may execute a movement gesture corresponding to a zoom command by created a closed fist at a point along a zoom vector identified by a system between the user and a display surface. In response to recognizing this example gesture, the processor 507 may initiate a zoom mode and then adjust content presented in the display as the users hand moves to change the zoom of the presented content.

The scene sensor 500, which may include stereo cameras, orientation sensors (e.g., accelerometers and an electronic compass) and distance sensors, may provide scene-related data (e.g., images) to a scene manager 510 implemented within the processor 507 which may be configured to interpret three-dimensional scene information. In various embodiments, the scene sensor 500 may include stereo cameras (as described below) and distance sensors, which may include infrared light emitters for illuminating the scene for an infrared camera. For example, in an embodiment illustrated in FIG. 5A, the scene sensor 500 may include a stereo red green-blue (RGB) camera 503a for gathering stereo images, and an infrared camera 503b configured to image the scene in infrared light which may be provided by a structured infrared light emitter 503c. The structured infrared light emitter may be configured to emit pulses of infrared light that may be imaged by the infrared camera 503b, with the time of received pixels being recorded and used to determine distances to image elements using time-of-flight calculations. Collectively, the stereo RGB camera 503a, the infrared camera 503b and the infrared emitter 503c may be referred to as an RGB-D (D for distance) camera 503.

The scene manager module 510 may scan the distance measurements and images provided by the scene sensor 500 in order to produce a three-dimensional reconstruction of the objects within the image, including distance from the stereo cameras and surface orientation information. In an embodiment, the scene sensor 500, and more particularly an RGB-D camera 503, may point in a direction aligned with the field of view of the user and the head mounted device 10. The scene sensor 500 may provide a full body three-dimensional motion capture and gesture recognition. The scene sensor 500 may have an infrared light emitter 503c combined with an infrared camera 503c, such as a monochrome CMOS sensor. The scene sensor 500 may further include stereo cameras 503a that capture three-dimensional video data. The scene sensor 500 may work in ambient light, sunlight or total darkness and may include an RGB-D camera as described herein. The scene sensor 500 may include a near-infrared (NIR) pulse illumination component, as well as an image sensor with a fast gating mechanism. Pulse signals may be collected for each pixel and correspond to locations from which the pulse was reflected and can be used to calculate the distance to a corresponding point on the captured subject.

In another embodiment, the scene sensor 500 may use other distance measuring technologies (i.e., different types of distance sensors) to capture the distance of the objects within the image, for example, ultrasound echo-location, radar, triangulation of stereoscopic images, etc. The scene sensor 500 may include a ranging camera, a flash LIDAR camera, a time-of-flight (ToF) camera, and/or a RGB-D camera 503, which may determine distances to objects using at least one of range-gated ToF sensing, RF-modulated ToF sensing, pulsed-light ToF sensing, and projected-light stereo sensing. In another embodiment, the scene sensor 500 may use a stereo camera 503a to capture stereo images of a scene, and determine distance based on a brightness of the captured pixels contained within the image. As mentioned above, for consistency any one or all of these types of distance measuring sensors and techniques are referred to herein generally as “distance sensors.” Multiple scene sensors of differing capabilities and resolution may be present to aid in the mapping of the physical environment, and accurate tracking of the user's position within the environment.

The head mounted device 10 may also include an audio sensor 505 such as a microphone or microphone array. An audio sensor 505 enables the head mounted device 10 to record audio, and conduct acoustic source localization and ambient noise suppression. The audio sensor 505 may capture audio and convert the audio signals to audio digital data. A processor associated with the control system may review the audio digital data and apply a speech recognition algorithm to convert the data to searchable text data. The processor may also review the generated text data for certain recognized commands or keywords and use recognized commands or keywords as input commands to execute one or more tasks. For example, a user may speak a command such as “initiate zoom mode” to have the system search for a control object along an expected zoom vector. As another example, the user may speak “close content” to close a file displaying content on the display.

The head mounted device 10 may also include a display 540. The display 540 may display images obtained by the camera within the scene sensor 500 or generated by a processor within or coupled to the head mounted device 10. In an embodiment, the display 540 may be a micro display. The display 540 may be a fully occluded display. In another embodiment, the display 540 may be a semitransparent display that can display images on a screen that the user can see through to view the surrounding room. The display 540 may be configured in a monocular or stereo (i.e., binocular) configuration. Alternatively, the head-mounted device 10 may be a helmet mounted display device, worn on the head, or as part of a helmet, which may have a small display 540 optic in front of one eye (monocular) or in front of both eyes (i.e., a binocular or stereo display). Alternatively, the head mounted device 10 may also include two display units 540 that are miniaturized and may be any one or more of cathode ray tube (CRT) displays, liquid crystal displays (LCDs), liquid crystal on silicon (LCos) displays, organic light emitting diode (OLED) displays, Mirasol displays based on Interferometric Modulator (IMOD) elements which are simple micro-electro-mechanical system (MEMS) devices, light guide displays and wave guide displays, and other display technologies that exist and that may be developed. In another embodiment, the display 540 may comprise multiple micro-displays 540 to increase total overall resolution and increase a field of view.

The head mounted device 10 may also include an audio output device 550, which may be a headphone and/or speaker collectively shown as reference numeral 550 to output audio. The head mounted device 10 may also include one or more processors that can provide control functions to the head mounted device 10 as well as generate images, such as of virtual objects. For example, the device 10 may include a core processor, an applications processor, a graphics processor and a navigation processor. Alternatively, the head mounted display 10 may be coupled to a separate processor, such as the processor in a smartphone or other mobile computing device. Video/audio output may be processed by the processor or by a mobile CPU, which is connected (via a wire or a wireless network) to the head mounted device 10. The head mounted device 10 may also include a scene manager block 510, a user control block 515, a surface manager block 520, an audio manager block 525 and an information access block 530, which may be separate circuit modules or implemented within the processor as software modules. The head mounted device 10 may further include a local memory and a wireless or wired interface for communicating with other devices or a local wireless or wired network in order to receive digital data from a remote memory 555. Using a remote memory 555 in the system may enable the head mounted device 10 to be made more lightweight by reducing memory chips and circuit boards in the device.

The scene manager block 510 of the controller may receive data from the scene sensor 500 and construct the virtual representation of the physical environment. For example, a laser may be used to emit laser light that is reflected from objects in a room and captured in a camera, with the round trip time of the light used to calculate distances to various objects and surfaces in the room. Such distance measurements may be used to determine the location, size and shape of objects in the room and to generate a map of the scene. Once a map is formulated, the scene manager block 510 may link the map to other generated maps to form a larger map of a predetermined area. In an embodiment, the scene and distance data may be transmitted to a server or other computing device which may generate an amalgamated or integrated map based on the image, distance and map data received from a number of head mounted devices (and over time as the user moved about within the scene). Such an integrated map data made available via wireless data links to the head mounted device processors.

The other maps may be maps scanned by the instant device or by other head mounted devices, or may be received from a cloud service. The scene manager 510 may identify surfaces and track the current position of the user based on data from the scene sensors 500. The user control block 515 may gather user control inputs to the system, for example audio commands, gestures, and input devices (e.g., keyboard, mouse). In an embodiment, the user control block 515 may include or be configured to access a gesture dictionary to interpret user body part movements identified by the scene manager 510, As discussed above a gesture dictionary may store movement data or patterns for recognizing gestures that may include pokes, pats, taps, pushes, guiding, flicks, turning, rotating, grabbing and pulling, two hands with palms open for panning images, drawing (e.g., finger painting), forming shapes with fingers, and swipes, all of which may be accomplished on or in close proximity to the apparent location of a virtual object in a generated display. The user control block 515 may also recognize compound commands. This may include two or more commands. For example, a gesture and a sound (e.g. clapping) or a voice control command (e.g. ‘OK’ detected hand gesture made and combined with a voice command or a spoken word to confirm an operation). When a user control 515 is identified the controller may provide a request to another subcomponent of the device 10.

The head mounted device 10 may also include a surface manager block 520. The surface manager block 520 may continuously track the positions of surfaces within the scene based on captured images (as managed by the scene manager block 510) and measurements from distance sensors. The surface manager block 520 may also continuously update positions of the virtual objects that are anchored on surfaces within the captured image. The surface manager block 520 may be responsible for active surfaces and windows. The audio manager block 525 may provide control instructions for audio input and audio output. The audio manager block 525 may construct an audio stream delivered to the headphones and speakers 550.

The information access block 530 may provide control instructions to mediate access to the digital information. Data may be stored on a local memory storage medium on the head mounted device 10. Data may also be stored on a remote data storage medium 555 on accessible digital devices, or data may be stored on a distributed cloud storage memory, which is accessible by the head mounted device 10. The information access block 530 communicates with a data store 555, which may be a memory, a disk, a remote memory, a cloud computing resource, or an integrated memory 555.

FIG. 6 illustrates an example of a computing system in which one or more embodiments may be implemented. A computer system as illustrated in FIG. 6 may be incorporated as part of the previously described computerized devices in FIGS. 4 and 5. Any component of a system according to various embodiments may include a computer system as described by FIG. 6, including various camera, display, HMD, and processing devices such as HMD 10, mobile computing device 8, camera 18, display 14, television display 114, computing device 108, camera 118, various electronic control objects, any element or portion of system 400 or the HMD 10 of FIG. 5A, or any other such computing device for use with various embodiments. FIG. 6 provides a schematic illustration of one embodiment of a computer system 600 that can perform the methods provided by various other embodiments, as described herein, and/or can function as the host computer system, a remote kiosk/terminal, a point-of-sale device, a mobile device, and/or a computer system. FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard and/or the like; and one or more output devices 620, which can include without limitation a display device, a printer and/or the like. The bus 605 may couple two or more of the processors 610, or multiple cores of a single processor or a plurality of processors. Processors 610 may be equivalent to processing module 420 or processor 507 in various embodiments. In certain embodiments, a processor 610 may be included in mobile device 8, television display 114, camera 18, computing device 108, HMD 10, or in any device or element of a device described herein.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or similar communication interfaces. The communications subsystem 630 may permit data to be exchanged with a network (such as the network described below, to name one example), other computer systems, and/or any other devices described herein. In many embodiments, the computer system 600 will further comprise a non-transitory working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, an activity selection subsystem configured to provide some or all of the features described herein relating to the selection of activities by a context assistance server 140 can comprise hardware and/or software that is specialized (e.g., an application-specific integrated circuit (ASIC), a software method, etc.) or generic (e.g., processor(s) 610, applications 645, etc.) Further, connection to other computing devices such as network input/output devices may be employed.

Some embodiments may employ a computer system (such as the computer system 600) to perform methods in accordance with the disclosure. For example, some or all of the procedures of the described methods may be performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communications subsystem 630 (and/or the media by which the communications subsystem 630 provides communication with other devices). Hence, transmission media can also take the form of waves (including without limitation radio, acoustic and/or light waves, such as those generated during radio-wave and infrared data communications). Such non-transitory embodiments of such memory may be used in mobile device 8, television display 114, camera 18, computing device 108, HMD 10, or in any device or element of a device described herein. Similarly, modules such a gesture analysis module 440 or content control module 450, or any other such module described herein may be implemented by instructions stored in such memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a non-transitory storage device 625 either before or after execution by the processor(s) 610.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted in a flow with process arrows. Although each may describe the operations as a sequential process, of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method comprising:
determining a range of motion of a control object associated with a user including a maximum extension and a minimum extension;
detecting, based on information from one or more detection devices, a movement of the control object substantially in a direction associated with a zoom command, wherein a minimum zoom amount and a maximum zoom amount for the zoom command are substantially matched to the maximum extension and the minimum extension; and
adjusting a current zoom amount of displayed content in response to the detection of the movement of the control object.

2. The method of claim 1 wherein the control object comprises a user's hand, and wherein detecting the movement of the control object substantially in the direction associated with the zoom command comprises:
detecting a current position of the user's hand in three dimensions;
estimating the direction as a motion path of the user's hand as the user pulls or pushes the hand toward or away from the user; and
detecting the motion path of the user's hand as the user pulls or pushes the hand toward or away from the user.

3. The method of claim 2 further comprising:
ending a zoom mode comprising the adjusting the current zoom amount by remotely detecting a zoom disengagement motion.

4. The method of claim 3 wherein the control object comprises a hand of the user; and
wherein detecting the zoom disengagement motion comprises detecting an open palm position of the hand after detecting a closed palm position of the hand.

5. The method of claim 4 wherein the one or more detection devices comprise an optical camera, a stereo camera, a depth camera, or a hand mounted inertial sensor.

6. The method of claim 3 wherein detecting the zoom disengagement motion comprises detecting that the control object has deviated from the direction associated with the zoom command by more than a threshold amount.

7. The method of claim 2
further comprising detecting a zoom initiating input, wherein the zoom initiating input comprises an open palm position of the hand followed by a closed palm position of the hand.

8. The method of claim 7 wherein a first location of the hand along the direction when a zoom initiating input is detected and matched to the current zoom amount to create a zoom match.

9. The method of claim 8 further comprising:
comparing the minimum zoom amount and the maximum zoom amount to a maximum single extension zoom amount; and
adjusting the zoom match to associate the minimum extension with a first capped zoom setting and the maximum extension with a second capped zoom setting;
wherein a zoom difference between the first capped zoom setting and the second capped zoom setting is less than or equal to the maximum single extension zoom amount.

10. The method of claim 9 further comprising:
ending a zoom mode by remotely detecting, using the one or more detection devices, a zoom disengagement motion when the hand is in a second location along a zoom vector in the direction associated with the zoom command different from the first location;
initiating, in response to a second zoom initiating input, a second zoom mode when the hand is at a third location along the zoom vector different from the second location; and
adjusting the first capped zoom setting and the second capped zoom setting in response to a difference along the zoom vector between the second location and the third location.

11. The method of claim 8 wherein adjusting the current zoom amount of the content in response to the detection of the movement of the control object along a zoom vector in the direction associated with the zoom command and based on the zoom match comprises:
identifying a maximum allowable zoom rate;
monitoring the movement of the control object along the zoom vector; and
setting a rate of change in zoom to the maximum allowable zoom rate when an associated movement along the zoom vector exceeds a rate threshold until the current zoom amount matches a current control object location on the zoom vector.

12. The method of claim 8 wherein the zoom match is further determined based on an analysis of an arm length of the user.

13. The method of claim 8 wherein the zoom match is estimated prior to a first gesture of the user based on one or more of torso size, height, or arm length; and
wherein the zoom match is updated based on an analysis of at least one gesture performed by the user.

14. The method of claim 8 wherein the zoom match identifies a dead zone for a space near the minimum extension.

15. An apparatus comprising:
a processing module comprising a processor;
a computer readable storage medium coupled to the processing module;
a display output module coupled to the processing module; and
an image capture module coupled to the processing module;
wherein the computer readable storage medium comprises computer readable instructions that, when executed by the processor, cause the processor to:
determine a range of motion of a control object associated with a user including a maximum extension and a minimum extension;
detect, based on information from one or more detection devices, a movement of the control object substantially in a direction associated with a zoom command, wherein a minimum zoom amount and a maximum zoom amount for the zoom command are substantially matched to the maximum extension and the minimum extension; and
adjust a current zoom amount of displayed content in response to the detection of the movement of the control object.

16. The apparatus of claim 15 wherein the computer readable instructions further cause the processor to:
detect a shift in the range of motion of the control object;
detect a second direction associated with the zoom command following the shift in the range of motion of the control object; and
adjust the current zoom amount of displayed content in response to the detection of the movement of the control object in the second direction.

17. The apparatus of claim 15 further comprising:
an audio sensor; and
a speaker;
wherein a zoom initiating input comprises a voice command received via the audio sensor.

18. The apparatus of claim 15 further comprising:
an antenna; and
a local area network module;
wherein the content is communicated to a display from the display output module via the local area network module.

19. The apparatus of claim 18 wherein the current zoom amount is communicated to a server infrastructure computer via the display output module.

20. The apparatus of claim 19 wherein the computer readable instructions further cause the processor to:
identify a maximum allowable zoom rate;
monitor the movement of the control object along a zoom vector from the minimum zoom amount to the maximum zoom amount; and
setting a rate of change in zoom to the maximum allowable zoom rate when an associated movement along the zoom vector exceeds a rate threshold until the current zoom amount matches a current control object location on the zoom vector.

21. The apparatus of claim 20 wherein the computer readable instructions further cause the processor to:
analyze a plurality of user gesture commands to adjust the minimum zoom amount and the maximum zoom amount.

22. The apparatus of claim 21 wherein the computer readable instructions further cause the processor to:
identify a first dead zone for a space near the minimum extension.

23. The apparatus of claim 22 wherein the computer readable instructions further cause the processor to:
identify a second dead zone near the maximum extension.

24. A apparatus of claim 20 wherein the an output display and a first camera are integrated as components of an HMD; and wherein the HMD further comprises a projector that projects a content image into an eye of the user.

25. A apparatus of claim 24 wherein the content image comprises content in a virtual display surface.

26. The apparatus of claim 25 wherein
a second camera is communicatively coupled to the processing module; and
wherein a gesture analysis module coupled to the processing module identifies an obstruction between the first camera and the control object and detects the movement of the control object along the zoom vector using a second image from the second camera.

27. A system comprising:
means for determining a range of motion of a control object associated with a user including a maximum extension and a minimum extension;
means for detecting, based on information from one or more detection devices, a movement of the control object substantially in a direction associated with a zoom command, wherein a minimum zoom amount and a maximum zoom amount for the zoom command are substantially matched to the maximum extension and the minimum extension; and
means for adjusting a current zoom amount of displayed content in response to the detection of the movement of the control object.

28. The system of claim 27 further comprising:
means for detecting a current position of a user's hand in three dimensions;
means for estimating the direction as a motion path of the user's hand as the user pulls or pushes the hand toward or away from the user; and
means for detecting the motion path of the user's hand as the user pulls or pushes the hand toward or away from the user.

29. The system of claim 27 further comprising:
means for ending a zoom mode by remotely detecting a zoom disengagement motion.

30. The system of claim 29 further comprising:
means for detecting control object movement where the control object is a hand of the user including detecting an open palm position of the hand after detecting a closed palm position of the hand.

31. The system of claim 27 further comprising:
means for comparing the minimum zoom amount and the maximum zoom amount to a maximum single extension zoom amount; and
means for adjusting a zoom match to associate the minimum extension with a first capped zoom setting and the maximum extension with a second capped zoom setting;
wherein a zoom difference between the first capped zoom setting and the second capped zoom setting is less than or equal to the maximum single extension zoom amount.

32. The system of claim 31 further comprising:
means for ending a zoom mode by remotely detecting, using the one or more detection devices, a zoom disengagement motion when the hand is in a second location along a zoom vector in the direction associated with the zoom command different from a first location;
means for initiating, in response to a second zoom initiating input, a second zoom mode when the hand is at a third location along the zoom vector different from the second location; and
means for adjusting the first capped zoom setting and the second capped zoom setting in response to a difference along the zoom vector between the second location and the third location.

33. A non-transitory computer readable storage medium comprising computer readable instruction that, when executed by a processor, cause a system to:
determining a range of motion of a control object associated with a user including a maximum extension and a minimum extension;
detecting, based on information from one or more detection devices, a movement of the control object substantially in a direction associated with a zoom command, wherein a minimum zoom amount and a maximum zoom amount for the zoom command are substantially matched to the maximum extension and the minimum extension; and
adjusting a current zoom amount of displayed content in response to the detection of the movement of the control object.
